(19) United States
(12) Patent Application Publication
(10) Pub. No.: US 2008/0140240 A1
(43) Pub. Date: Jun. 12, 2008

(54) VEHICULAR SYSTEM FOR PLAYING AUDIO FILES

(76) Inventors: ROBERT McCALL WHITE, DANVILLE, CA (US); TED TSUCHIYAMA, ALAMO, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/955,179

(22) Filed: Dec. 12, 2007

Related U.S. Application Data
(60) Provisional application No. 60/869,567, filed on Dec. 12, 2006.

(51) Int. Cl. G06F 17/00

(52) U.S. Cl. 700/94

(57) ABSTRACT

A system for transferring, storing and/or playing at least one audio file operatively associated with at least one vehicular device. When a vehicular device is activated, the system of the present invention plays at least one audio file associated with the vehicular device. In a preferred embodiment, the invention may be used to play at least one audio file when at least one turn signal is activated.

### CROSS REFERENCES TO RELATED APPLICATIONS

This U.S. Non-provisional Application claims the benefit of priority, under 35 U.S.C. §119(e) to U.S. Provisional Application No. 60/869,567, filed on Dec. 12, 2006.

### FIELD OF THE INVENTION

The present invention is directed to an audio player operatively associated with a vehicle. In particular, the present invention is directed to a system for recording, transferring, storing and/or playing audio files when a vehicular device, such as a turn signal of an automobile, is activated.

### BACKGROUND OF THE INVENTION

Individualized ring tones have become very popular in recent days. There are a multitude of systems and devices for downloading ring tones and other sounds. The majority of these technologies are directed to cell phones and the like. While there have been technologies directed toward playing downloaded sounds, none have been used in or with vehicular devices, such as automotive turn signals. The following are exemplary patents which relate to automotive turn signals.

U.S. Pat. No. 6,426,695 to Pagano discloses a volume control for an automobile turn signal indicator. The volume control allows a driver to raise or lower the volume of the clicking sound that is produced when a turn signal indicator is activated. As such, the driver is able to increase the volume of the audible clicking sound when operating in an environment having a high background noise (i.e. a radio or traffic) or when the driver is hearing impaired.

U.S Pat. No 6,154,125 to McAuley discloses an audible pedestrian alert system for use with vehicles having a wide turning radius such as buses and trucks. The alert device is disposed in the rear wheel well of the vehicle and is operatively connected to a conventional vehicle turn signal circuit. The device may be selectively connected to a first turn signal indicator lamp and a second turn signal indicator lamp. Additionally, the device includes a sound generating means and a timing and signal conditioning circuit operatively connected to a turn signal switch. Upon activation of the turn signal switch, a pulsed tone is produced for a pre-determined period of time.

U.S. Pat. No. 5,309,143 to Brown discloses a vehicle turn signal malfunction warning system that alerts a driver when a turn signal indication is not cancelled after a predetermined time period. The device comprises a modular housing that is plug-compatible with all standardized flasher units in use and requires no wiring to be connected to the turn signal system or to the vehicle electrical system. The system includes a full-wave rectifier connected across the inputs of the standard turn signal flasher and is powered solely by the voltage derived from the turn signal system. The warning system includes a first time base circuit, a second time base circuit, a gating means, and a tone generator means. The first time base circuit is arranged to be fully charged by the first turn signal pulse through the full-wave rectifier and should discharge approximately 2.5 seconds after the turn signal pulse train ends. The second time base circuit begins charging when the first time base is fully charged, and accumulates a charge until the first time base circuit resets. The cumulative charge of the second time base circuit is connected through a zener diode to a gate, and thence to an audible transducer. After the turn signal has operated for a predetermined time period, a sufficient number of turn signal pulses will have been generated to raise the voltage of the second time base circuit above the zener diode threshold, the gating means will switch on and the audible warning will sound. Cancellation of the turn signal indication will immediately stop the audible warning.

U.S. Pat. No. 5,264,827 to Giovanni discloses a turn signal reminder circuit for warning a driver that the turn signals of a vehicle may have been inadvertently left actuated. Turn signal flasher pulses are low pass filtered to provide a continuous enabling signal which initiates the operation of an a stable, multivibrator timer circuit. The timer circuit switches asymmetrically between a first occurring longer-time, partial cycle, and a shorter-timer, partial cycle. A sound alarm is enabled by the timer during each shorter-time, partial cycle. The alarm is actuated by flasher pulses when the alarm is enabled, but the alarm is disabled and the timer circuit is reset in response to operation of the vehicle brake.

While various forms of audible indicators have been associated with vehicular devices, such as automotive turn signals, there has not been a system that enables a user to select and play at least one audio file when a turn signal or other vehicular device is activated.

### SUMMARY OF THE INVENTION

The invention is directed to a system and method for transferring, storing and playing an audio file.

In one aspect, the system includes an apparatus operatively associated with at least one vehicular device, wherein the audio file is played upon activating the vehicular device. The apparatus comprises an input/output device, a memory unit, a controller, and an audio file playing means.

In another aspect of the invention, the system includes an apparatus for transferring, storing and playing an audio file operatively associated with a turn signal of a vehicle, wherein the audio file is played upon activating the turn signal.

The invention is further directed to a method for transferring, storing and playing an audio file. The method involves the steps of providing an apparatus that is operatively associated with a turn signal, wherein the audio file is played upon activating the turn signal; transferring an audio file to the apparatus; storing the audio file in a memory unit of said apparatus; assigning the audio file to a turn signal; and activating a turn signal to initiate playback of the audio file.

### BRIEF DESCRIPTION OF THE FIGURES

FIG. 1 is a block diagram showing an exemplary embodiment of the system of the present invention.

FIG. 2 is a diagram of a user interface for accessing audio files and programming the system of the present invention.

FIG. 3 is a flow chart showing a method for using the system of the present invention

### DETAILED DESCRIPTION OF THE INVENTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

It must be noted that as used herein and in the appended claims, the singular forms “a”, “an”, and “the” include plural references unless the context clearly dictates otherwise. Thus, for example, reference to “a speaker” includes a plurality of speakers and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

Furthermore, unless otherwise defined, all technical and scientific terms used herein have the same meaning as commonly understood by one of ordinary skill in the art to which this invention belongs. For purposes of this application, “audio files” may include, but is not limited to, any analog sound recordings or digital sound recording, such as uncompressed digital recordings and compressed digital recordings, and combinations thereof. Audio files may also include any sound file streamed from a radio station or over the internet. Exemplary audio files formats may include MPEG Layer-3 (MP3), MPEG Layer-4 (MP4), Windows Media Audio (WMA), and Real Audio (RA).

“Vehicle” may include, but is not limited to, any motorized means of transportation, such as automobiles, motorcycles, watercraft or aircraft, as well as any steam, electrical or magnetic based means of transportation such as trains and rail cars.

“Vehicular device” may include, but is not limited to, any device of a vehicle, such as at least one turn signal, headlights, interior lights, window shield wipers, at least one gear shift, gas gauge, oil gauge, speedometer, odometer, battery, cruise control, at least one window, sunroof, convertible top, at least one door, at least one door lock mechanism, trunk, trunk locking mechanism, heating or air conditioning system, at least one seat belt or a combination thereof.

Additionally, “personal recording” may include, but is not limited to, any sound recording made by a user, such as a recording of a user's own voice, a loved one's voice, a sound of nature, or any other self made sound recording.

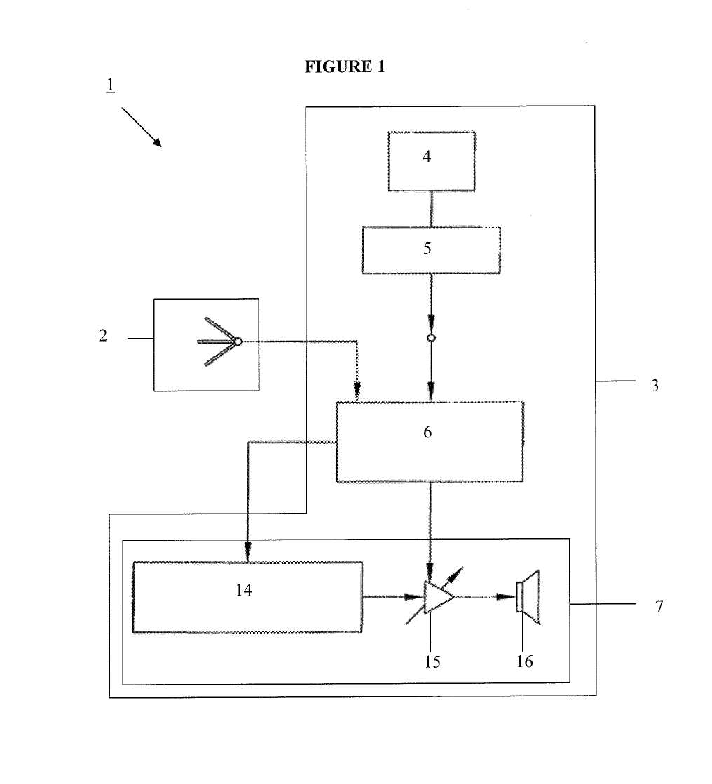

The present invention is described with reference to the enclosed figures, wherein the same numbers are used where applicable. FIG. 1 is a block diagram illustrating a system in accordance with an exemplary embodiment of the present invention. As shown in FIG. 1, the invention is directed to a novel system 1 which may be used to obtain, transfer, record, store, select, assign and/or play at least one audio file upon activation of at least one vehicular device 2. Therefore, upon activating at least one vehicular device 2, an operator of a vehicle can hear music, a loved one's voice, and/or other recorded or preselected sounds.

As shown in FIG. 1, system 1 may include at least one vehicular device 2 and an apparatus 3. As defined above, vehicular device 2 may include any device of a vehicle, preferably a turn signal. In an exemplary embodiment, system 1 of the present invention may be operatively associated with one vehicular device 2, more preferably, at least two vehicular devices 2, and most preferably, at least 3 vehicular devices 2. System 1 may be programmed such that at least one audio file or a portion of an audio file, more preferably multiple audio files, may be assigned to each vehicular device 2. In one embodiment, vehicular device 2 may be assigned to a preselected or randomized compilation of audio files. In another embodiment, each vehicular device 2 may be assigned a different audio file or set of audio files.

According to the present invention, apparatus 3 may include an input/output device 4, a memory unit 5, a controller 6, and an audio file playing means 7. Apparatus 3 may be connected to or operatively associated with vehicular device 2, so as to enable the receipt, transfer, recording, storage, selection, assignment and/or playing of at least one audio file. When vehicular device 2 is activated, apparatus 3 plays at least one preselected audio file, which may include, but is not limited to, any recorded song, message, or other sounds. It is to be appreciated that system 1 may be used to play a wide variety of sounds. The sound may be used to remind an operator that a vehicular device 2, such as a turn signal, has been activated. Additionally, it may be used to alert an operator to a situation associated with the vehicle, such as an unlocked or open door, a low gas gauge, or when the vehicle is exceeding a preselected speed limit. Optionally, it may also indicate when an operator has not taken a specific action. For example, it may alert an operator that: the window shield wipers have been activated without turning on the headlights; the headlights have not been activated after a designated time or upon triggering of a darkness sensor; or an operator or passenger is not wearing a seat belt.

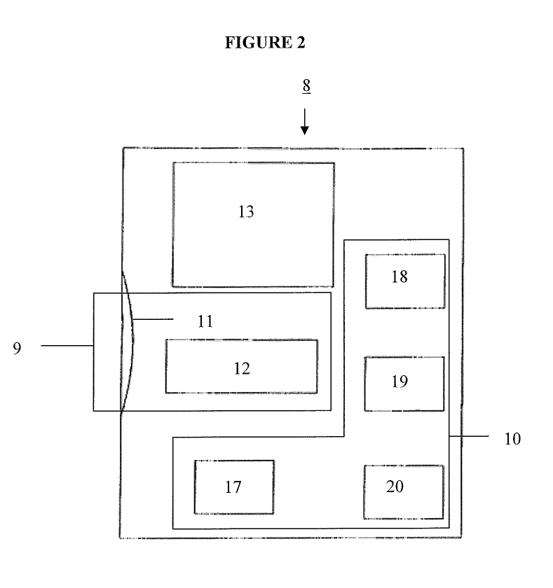

Input/output device 4 of apparatus 3 may function to obtain, transfer, record, and/or select at least one audio file and otherwise program system 1. Input/output device 4 may include any suitable user interface 8 to enable an operator to control the operation of apparatus 3 and/or system 1. In an exemplary embodiment, user interface 8 may include an audio file transfer means 9 and a control means 10, as shown in FIG. 2.

At least one audio file may be transferred to or from apparatus 3 using any conventional transfer means 9. In an exemplary embodiment, transfer means 9 may include docking station 11 and/or downloading station 12. An audio file may be transferred from any device capable of storing an audio file by connecting said device to docking station 11 using any standard connector, such as a USB cable. Preferably, docking station 11 may accept any memory device, such as an MP3 player, a flash drive, a cell phone or any audio recorder. User interface 8 may also include downloading station 12 for enabling remote wireless transfer and/or receipt of at least one audio file.

User interface 8 may also include a control means 10 that enables a user to control the operation of apparatus 3 and/or system 1. Specifically, control means 10 may instruct apparatus 3 to: browse a selection of or search for audio files on a device directly, remotely, or operatively connected to apparatus 3; initiate transfer of at least one audio file to apparatus 3; make at least one audio recording; label at least one audio file; store at least one audio file in memory unit 5; select at least one audio file stored in memory unit 5; select at least one vehicular device 2 for which at least one audio file is to be assigned; assign at least one audio file to at least one vehicular device 2; unassign at least one audio file from at least one vehicular device 2; save a selected audio file or a selected set of audio files for at least one vehicular device 2; randomize playback of a set of audio files upon activation of a vehicular device 2; adjust and/or set the volume, clarity or tone of the sound produced from an audio file playing means 7; adjust and/or set the length of time for which at least one audio file is played; stop the playback of an audio file; initiate transfer of at least one audio file from apparatus 3; or any combination thereof. Control means 10 may include a touch screen interface, a voice activated interface, a conventional manual interface or a combination thereof capable of performing the above functions. In a preferred embodiment, control means 10 is a manual interface that includes at least one button and/or keypad.

Optionally, user interface 8 may further comprise a graphical interface 13. Graphical interface 13 may be used to display: a list of audio files stored on a device directly, remotely or operatively connected to apparatus 3; a list of the audio files stored on apparatus 3; at least one audio file and its correspondingly assigned vehicular device 2; a list of audio files which have been assigned to vehicular device 2; a saved selection of audio files and/or a list of their corresponding vehicular devices 2; a list of audio files currently being played; or a combination thereof.

Input/output device 4 may optionally also include an audio recorder. In addition to obtaining prerecorded audio files from an external source, apparatus 3 may be capable of making audio recordings. A user may thus be able to record messages. In one embodiment, system 1 may be programmed to play a recording reminding the user of tasks to be accomplished. In another embodiment, system 1 may be programmed to play a recording reminding the user of actions associated with the vehicle, such as reminders to turn left or right, to turn on the headlights or to buckle-up. For example, system 1 may be connected to or operatively associated with a sensor monitoring the odometer, oil gauge, or gas gauge and may be programmed to play a recording reminding the user to maintenance the vehicle. Preferably, system 1 may be used to record and play any personal recording, including a recording of a loved one's voice, such as a grandchild's voice.

The transferred or recorded audio files may be subsequently stored in memory unit 5. Memory unit 5 may be any suitable memory device capable of storing a wide variety of audio file formats and may have a capacity for storing at least one audio file, preferably a plurality of audio files. In a preferred embodiment, memory unit 5 has a storage capacity of at least 512 megabytes, more preferably at least 1 gigabyte and most preferably, at least 10 gigabytes.

A controller 6 may be connected to or operatively associated with at least one vehicular device 2, preferably multiple vehicular devices 2. When a vehicular device 2 is activated, controller 6 instructs an audio playing means 7 to play at least one audio file assigned to vehicular device 2, as programmed. Controller 6 may also instruct the an audio playing means 7 to adjust a volume, clarity or tone of a sound produced by apparatus 3.

Audio file playing means 7 may include any suitable system for playing at least one audio file. In one embodiment, audio file playing means 7 may comprise an audio generator 14, a sound quality system 15, at least one speaker 16 or a combination thereof. Controller 6 may instruct audio generator 14 to produce and speaker 16 to project a preselected sound. Sound quality system 15 may be adjusted using user interface 8 to increase or decrease the volume, clarity, tone, base, treble or other aspect of a produced sound. In another embodiment, apparatus 3 may be connected to or operatively associated with an existing audio system of the vehicle or an audio system otherwise attached to the vehicle, such as an existing stereo system or an attached MP3 player. The selected audio files may be played from the speakers of the existing audio system. Alternatively, controller 6 may be programmed to turn on the radio; play a tape, CD or other sound recording; or play a saved song or audio file selection from the existing audio system or from an audio system otherwise connected to or operatively associated with the vehicle.

In a specific embodiment, as shown in FIG. 1, system 1 is designed to play at least one audio file upon activation of a vehicular device 2, namely a turn signal. Right turn and left turn levers may be connected to or operatively associated with controller 6. Upon activation of a lever, controller 6 may be programmed to play, using an audio generator 14, at least one preselected audio file stored in memory unit 5. The clarity, volume and duration of the playback may be adjusted using sound quality system 15. As shown in FIG. 2, apparatus 3 is programmed using control means 10, which includes an audio file selection button 17 and a set of buttons for assigning at least one audio file. For example, buttons 18-20 may be used to assign and designate at least one audio file to play when a respective left turn signal, right turn signal or either turn signal is activated. Preferably the left turn signal and the right turn signal are assigned different audio files.

In another aspect, a method for using system 1 of present invention may involve obtaining at least one audio file by browsing a selection of or searching for specific audio files on a device directly, remotely or operatively connected to apparatus 3. The selected audio files may be subsequently transferred to apparatus 3 using transfer means 9. Additionally, a user may use input/output device 12 to record a message, a song, or other sound, which may be formatted as an audio file. A user may then label and store at least one audio file in memory unit 5. Additionally, if desired, transfer means 9 may also transfer audio files from apparatus 3 to an audio file storage device.

Apparatus 3 may be subsequently programmed by selecting and assigning at least one audio file stored in memory unit 5 to at least one selected vehicular device 2. Apparatus 3 may further be programmed to save a particular audio assignment, unassign or reassign at least one audio file to at least one vehicular device 2. A user may also instruct apparatus 3 to randomly assign at least one audio file to at least one vehicular device 2. Additionally, a user may also adjust the playback duration and portion of the audio file as well as the volume or sound clarity using user interface 8.

Upon activation of at least one vehicular device 2, the controller 6 may instruct audio file playing means 7 to play at least one preselected audio file assigned to vehicular device 2, as programmed. The audio file may be played for a preset duration. However, the user interface 8 may include a means for stopping playback at any time.

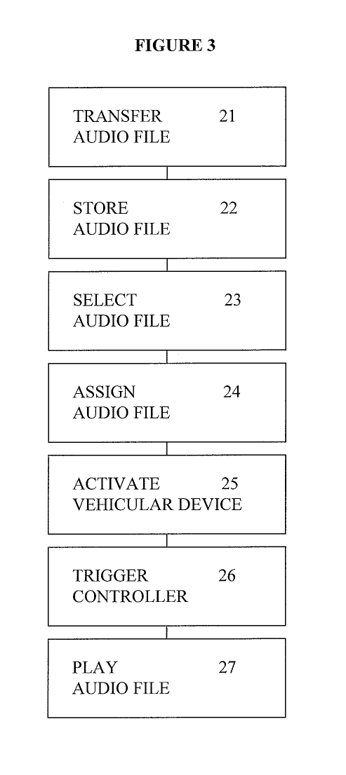

FIG. 3 illustrates a preferred method for using system 1 of the present invention. The method involves transferring at least one audio file to apparatus 21; storing at least one audio file in memory unit 22; selecting at least one audio file 23; programming apparatus so that the selected audio file is assigned to at least one vehicular device 24; activating at least one vehicular device 25; triggering controller 26 and subsequently playing at least one audio file assigned to the activated vehicular device 27.

For illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown. The terminology used herein is for the purpose of description and not of limitation, Further, although certain methods are described with reference to certain steps that are presented herein in certain order, in many instances, these steps may be performed in any order as may be appreciated by one skilled in the art, and the methods are not limited to the particular arrangement of steps disclosed herein.

1. A system for transferring, storing and playing an audio file comprising:
an apparatus comprising:
an input/output device;
a memory unit;
a controller; and
an audio file playing means; and
a vehicular device operatively associated with said system, wherein said audio file is played upon activating said vehicular device.

2. The system of claim 1, wherein said audio file is selected from the group consisting of: analog sound recordings, uncompressed digital sound recordings and compressed digital sound recordings.

3. The system of claim 2, wherein said compressed digital sound recordings is selected from the group consisting of: at least one MP3 file, at least one MP4 file, at least one WMA file, at least one RA file and a combination thereof.

4. The system of claim 1, wherein said system comprises at least two vehicular devices.

5. The system of claim 1, wherein said vehicular device is selected from the group consisting of: at least one turn signal, headlights, interior lights, window shield wipers, at least one gear shift, gas gauge, oil gauge, speedometer, odometer, battery, cruise control, at least one window, sunroof, convertible top, at least one door, at least one door lock mechanism, trunk, trunk locking mechanism, heat or air conditioning system, at least one seat belt and a combination thereof.

6. The system of claim 5, wherein said vehicular device comprises a turn signal.

7. The system of claim 5, wherein said input/output device comprises a user interface comprising an audio file transfer means and a control means.

8. The system of claim 5, wherein said control means is selected from the group consisting of: a touch screen interface, a voice activated interface and a manual interface, wherein said control means is capable of initiating transfer of said audio file from a device directly, remotely, or operatively connected to said apparatus, instructing said memory unit to store said audio file and assigning said audio file to said vehicular device.

9. The system of claim 7, wherein said vehicular device is a left turn signal and a right turn signal and wherein said control means is capable of selecting said audio file, assigning a first audio file to a left turn signal and assigning a second audio file to a right turn signal.

10. The system of claim 7, wherein said audio file transfer means is selected from the group consisting of: a docking station capable of transferring said audio file from a memory device, a downloading station capable of enabling remote transfer of said audio file and a combination thereof.

11. The system of claim 10, wherein said transfer means is a docking station capable of transferring said audio file from a memory device, wherein said memory device is selected from the group consisting of: an MP3 player, a flash drive, a cell phone and an audio recorder.

12. The system of claim 1, wherein said input/output device further comprises a recording means.

13. The system of claim 7, wherein said input/output device further comprises a recording means.

14. The system of claim 5, wherein said input/output device further comprises a graphical interface capable of displaying information, wherein said information is selected from the group consisting of: a list of audio files stored on a device directly, remotely or operatively connected to said apparatus; a list of audio files stored in said apparatus; said audio file and its correspondingly assigned vehicular device; and a combination thereof.

15. A system for transferring, storing and playing at least one audio file comprising:
an apparatus; and
a turn signal of a vehicle operatively associated with said apparatus, wherein said
audio file is played upon activation of said turn signal.

16. The system of claim 15, wherein said apparatus comprises: an input/output device, a memory unit, a controller, and an audio file playing means.

17. The system of claim 15, wherein said input/output device is capable of selecting said audio file, assigning a first audio file to a left turn signal and assigning a second audio file to a right turn signal.

18. A method for transferring, storing and playing at least one audio file comprising the steps of:
a. providing an apparatus operatively associated with a turn signal of a vehicle, wherein said audio file is played upon activating said turn signal;
b. transferring at least one audio file to said apparatus;
c. storing said audio file in a memory unit of said apparatus;
d. assigning said audio file to said turn signal; and
e. activating said turn signal to initiate playback of said audio file.

19. The method of claim 18, wherein step d involves assigning a first audio file to a left turn signal and assigning a second audio file to a right turn signal.

20. The method of claim 18, wherein said audio file is a voice recording.
